(19) United States
(12) Patent Application Publication
(10) Pub. No.: US 2017/0264444 A1
(43) Pub. Date: Sep. 14, 2017

(54) METHOD AND APPARATUSES FOR PERFORMING ONLINE CHARGING TO GCS-AS BASED ON RO INTERFACE

(71) Applicant: Alcatel Lucent, Boulongne-Billancourt (FR)

(72) Inventors: Xiangyang LI, Shanghai (CN); Yigang CAI, Naperville, IL (US)

(73) Assignee: Alcatel Lucent, Boulongne-Billancourt (FR)

(21) Appl. No.: 15/532,243

(22) PCT Filed: Oct. 22, 2015
(86) PCT No.: PCT/IB2015/002248

§ 371 Date: Jun. 1, 2017

(30) Foreign Application Priority Data
Dec. 8, 2014 (CN) 201410743449.7

(51) Int. Cl. H04L 12/14; H04W 4/08; H04L 12/18; H04W 4/00

(52) U.S. Cl. CPC H04L 12/1407; H04W 4/005; H04W 4/08; H04L 12/1435; H04L 12/185; H04M 15/8011

(57) ABSTRACT

An OCS performs online charging to usage of GCS-AS service data in response to an online charging initial request; and the OCS sends a granted service unit and valid time information about a UE to the GCS-AS in response to the online charging initial request, based on an GCS-AS Ro interface. The GCS-AS sends the GCS-AS service data corresponding to the granted service unit, the valid time information, and a corresponding key to the UE. If the GCS-AS service data is based on the EPS bearer, the OCS performs online charging to usage of the GCS-AS service data based on a special rating group. If the GCS-AS service data is based on an MBMS bearer, the OCS charges a content provider for providing the GCS service data.

### FIELD OF THE INVENTION

The invention relates to the field of communication technology, and more particularly, a technology of performing online charging to GCS over LTE EPS/MBMS.

### BACKGROUND OF THE INVENTION

3GPP 4G LTE introduces eMBMS (evolved multimedia broadcast multicast service) solution, which only supports the broadcast mode. Currently, the broadcast mode doesn't support the end-user level charging.

3GPP 4G LTE also introduces the Group Communication System Enablers for LTE. The Group Communication Service (GCS) Application Server (AS) can use EPS bearer services and may use in addition MBMS bearer services for transferring application signaling and data between the GCS AS and the UEs, especially for eMBMS-based Group Messaging for Machine Type Communications (MTC). This will create the problem how to charge the end users who use the GCS-AS. If we keep the GCS-AS user data over EPS bearer level as the current charging solution, but the MSMB bearer cannot be charged (this because the BM-SC (Broadcast Multimedia-Service Center) can not obtain resource usage of eMBMS for a single user, such as traffic, the length of time), this will be unfair for user who use EPS bearer to have GCS.

GCS application service can be transferred over LTE EPS bearer or MBMS bearer, how to charge GCS AS at per user base will be a problem.

The 3GPP doesn't define any charging solution how to charge GCS application services over LTE EPS MBMS per user base. However, service providers indeed have a need to charge end user in MBMS group messaging for MTC.

### SUMMARY OF THE INVENTION

An objective of this invention is to provide a method and apparatus for performing online charging to GCS over LTE EPS/MBMS.

According to one aspect of this invention, there provides a method for a method for performing online charging to GCS over LTE EPS/MBMS, wherein the method comprises the following steps of:

a. if a UE initiates a session to a GCS-AS device, the GCS-AS device sending an online charging initial request to a corresponding OCS device, based on a GCS-AS Ro interface;

b. the OCS device sending a granted service unit and valid time information about the UE to the GCS-AS device in response to said online charging initial request, based on said GCS-AS Ro interface, wherein the user balance corresponding to the UE satisfies a predetermined threshold;

c. the GCS-AS device sending the GCS-AS service data corresponding to said granted service unit, said valid time information, and a corresponding key to the UE, so as to make the UE decode said GCS-AS service data based on said key within said valid time information;

wherein the method further comprises:

d. the OCS device further performing online charging to usage of said GCS-AS service data in response to said online charging initial request;

e. if said GCS-AS service data is based on the EPS bearer, the OCS device performing online charging to usage of said GCS-AS service data based on a special rating group, wherein said special rating group is allocated by a PCRF device for said GCS-AS service data, and usage of said GCS-AS service data is transferred via a Gy interface;

f. if said GCS-AS service data is based on the MBMS bearer, the OCS device charging a content provider for providing said GCS service data in response to an online charging request that a BM-SC device sends to the OCS device via a MBMS Ro interface.

According to another aspect of this invention, there also provides a GCS-AS device, for performing online charging to GCS over LTE EPS/MBMS, wherein the GCS-AS device comprises:

a first sending apparatus configured to, if a UE initiates a session to a GCS-AS device, send an online charging initial request to a corresponding OCS device, based on a GCS-AS Ro interface;

a second receiving apparatus configured to, receive a granted service unit and valid time information about the UE, which are sent by the OCS device according to said online charging initial request;

a third sending apparatus configured to, send the GCS-AS service data corresponding to said granted service unit, said valid time information, and a corresponding key to the UE, so as to make the UE decode said GCS-AS service data based on said key within said valid time information.

According to a further aspect of this invention, there also provides an OCS device for performing online charging to GCS over LTE EPS/MBMS, wherein the OCS device comprises:

a first receiving apparatus configured to, receive an online charging initial request, which is sent by a corresponding a GCS-AS device based on a GCS-AS Ro interface when receiving a session initiated by a UE;

a second sending apparatus configured to, send a granted service unit and valid time information about the UE to the GCS-AS device in response to said online charging initial request, based on said GCS-AS Ro interface, wherein the user balance corresponding to the UE satisfies a predetermined threshold;

wherein, the OCS device further comprises:

a first charging apparatus configured to, perform online charging to usage of GCS-AS service data corresponding to said granted service unit in response to said online charging initial request;

a second charging apparatus configured to, if said GCS-AS service data is based on the EPS bearer, perform online charging to usage of said GCS-AS service data based on a received special rating group which is allocated for said GCS-AS service data, wherein usage of said GCS-AS service data is transferred via a Gy interface;

wherein, the OCS device further comprises:

a sixth receiving apparatus configured to, receive an online charging request, which is sent by a corresponding BM-SC device when said GCS-AS service data is based on the MBMS bearer, based on a MBMS Ro interface;

a third apparatus configured to, according to said online charging request, charge a content provider for providing said GCS service data.

According to a further aspect of this invention, there also provides a BM-SC device for performing online charging to GCS over LTE EPS/MBMS, wherein the BM-SC device comprises:

a sixth sending apparatus configured to, if GCS-AS service data corresponding to the granted service unit of a UE is based on the MBMS bearer, send an online charging request to a corresponding OCS device, based on a MBMS Ro interface.

According to another aspect of this invention, there also provides a system for performing online charging to GCS over LTE EPS/MBMS, wherein the system comprises the aforementioned GCS-AS device according to another aspect of the invention, the aforementioned OCS device according to a further aspect of the invention, and the aforementioned BM-SC device according to a further aspect of the invention.

Compared with the prior art, one embodiment of the present invention introduces a MBMS Ro interface which is used to charge per content provider for GCS-AS service usage over MBMS bearer. If the GCS-AS service data is based on the MBMS bearer, the OCS device charges a content provider for providing said GCS service data in response to an online charging request that a BM-SC device sends to the OCS device via a MBMS Ro interface. Therefore, the invention realizes the per-user MBMS online charging. Meanwhile, another embodiment of the present invention also introduces a GCS-AS Ro interface, which is used to charge per UE's GCS-AS service usage, and the OCS device uses a special rating group to perform online charging to the GCS-AS service based on EPS bearer, wherein said special rating group is allocated by a PCRF device for said GCS-AS service data, and the GCS-AS service based on EPS bearer is transferred via a Gy interface to the OCS device. Therefore, the invention can avoid the double charging issue for both charging triggers from GCS-AS Ro and Gy online charging, in other words, the invention achieves the beneficial effects that it can not charge the end user using GCS-AS Ro and Gy simultaneously, thereby, the invention implements an effective and fair charging to all users who use GCS-AS service over LTE EPS/MBMS by using different charging interface (that is, the GCS-AS Ro interface, the MBMS Ro interface and the Gy interface) to charge the GCS-AS service.

### BRIEF DESCRIPTION OF THE DRAWINGS

Other features, aims and advantages of this invention will become more apparent through reading the detailed statement of the non-restrictive embodiments made with reference to the following accompanying drawings:

FIG. 1 shows a schematic diagram illustrating a GCS-AS device, an OCS device and a BM-SC device for performing online charging to GCS over LTE EPS/MBMS according to one aspect of the present invention;

FIG. 2 shows a schematic diagram illustrating the GCS online charging for non-roaming network architecture model (the provider of GCS-AS service and the mobile network are the same);

FIG. 3 shows a schematic diagram illustrating the GCS online charging for non-roaming network architecture model (the provider of GCS-AS service and the mobile network are different);

FIG. 4 shows a schematic diagram illustrating the GCS online charging for Home Routed Roaming network architecture model (the provider of GCS-AS service and the mobile network are the same);

FIG. 5 shows a schematic diagram illustrating the GCS online charging for Local Breakout Roaming network architecture model (the provider of GCS-AS service and the mobile network are different);

FIG. 6 shows a schematic diagram illustrating the GCS online charging for Local Breakout Roaming network architecture model (the provider of GCS-AS service and the mobile network are the same);

FIG. 7 shows a flowchart of a method for performing online charging to GCS over LTE EPS/MBMS with cooperation among a GCS-AS device, an OCS device and a BM-SC device according to another embodiment of the present invention.

The same or similar reference signs in the drawings represent the same or similar component parts.

### DETAILED DESCRIPTION OF THE PREFERRED EMBODIMENTS

Details of the invention will be further provided below in combination with the accompanying drawings.

FIG. 1 shows a schematic diagram illustrating a GCS-AS device 1, an OCS device 2 and a BM-SC device 3 for performing online charging to GCS over LTE EPS/MBMS according to one aspect of the present invention, wherein the GCS-AS device 1 comprises a first sending apparatus 11, a second receiving apparatus 12, and a third sending apparatus 13; the OCS device 2 comprises a first receiving apparatus 21, a second sending apparatus 22, a first charging apparatus 23, a second charging apparatus 24, a sixth receiving apparatus 25 and a third charging apparatus 26; a BM-SC device 3 comprises a sixth sending apparatus 31. Specifically, if the UE initiates a session to the GCS-AS device 1, the first sending apparatus 11 of the GCS-AS device 1 sends an online charging initial request to the corresponding OCS device 2 based on the GCS-AS Ro interface; correspondingly, the first receiving apparatus 21 of the OCS device 2 receives the online charging initial request sent by the corresponding GCS-AS device 1 via the GCS-AS Ro interface when receiving the UE-initiated session; the first charging apparatus 23 of the OCS device 2 further performs online charging to usage of the GCS-AS service data in response to the online charging initial request; the second sending apparatus 22 of the OCS device 2 sends the granted service unit and valid time information about the UE to the GCS-AS device 1 via the GCS-AS Ro interface in response to the online charging initial request, wherein the user balance corresponding to the UE satisfies a predetermined threshold; correspondingly, the second receiving apparatus 12 of the GCS-AS device 1 receives the granted service unit and valid time information about the UE as sent by the OCS device 2 based on the online charging initial request; the third sending apparatus 13 sends the GCS-AS service data corresponding to the granted service unit, the valid time information, and the corresponding key to the UE, so as to make the UE decode the GCS-AS service data based on the key within the valid time information; if the GCS-AS service data are based on the EPS bearer, the second charging apparatus 24 of the OCS device 2 performs online charging to usage of the GCS-AS service data based on the received specific rating group which is allocated for the GCS-AS service data corresponding to the granted service unit, wherein usage of the GCS-AS service data is transferred via a Gy interface; if the GCS-AS service data corresponding to the granted service unit of UE is based on the MBMS bearer, the sixth sending apparatus 31 of the BM-SC device 3 sends an online charging request to the corresponding OCS device 2 based on the MBMS Ro interface; correspondingly, the sixth receiving apparatus 25 of the OCS device 2 receives, via the MBMS Ro interface, an online charging request sent by the corresponding BM-SC device 3 when the GCS-AS service data are based on the MBMS bearer; the third charging apparatus 26 charges the content provider of the GCS service data according to the online charging request.

Here, the GCS-AS device 1 refers to a Group Communication Service (GCS) Application Server (AS) can use EPS bearer services and may use in addition MBMS bearer services for transferring application signaling and data between the GCS AS device 1 and the UE(s). In a specific embodiment, the GCS-AS device 1 may be an existing GCS-AS, e.g., the GCS-AS for a group communication system as introduced in the 3GPP 4G LTE, which may also be derived by enhancing the existing GCS-AS.

Here, the OCS device 2 refers to an Online Charging System (OCS) that may perform real-time interactive charging with the system based on services usage. In a specific embodiment, the OCS device 2 may be an existing OCS or derived from enhancing the existing OCS.

Here, the BM-SC device 3 refers to a functional entity (i.e., a broadcast multicast service center) that may perform provision and management of MBMS service. For example, for a content provider, the BM-SC device 3 is an entry for the MBMS service content; for a bearer network, the BM-SC device 3 is configured to authorize and initiate the MBMS service and schedule and transmit the MBMS service content. In an specific embodiment, the BM-SC device 3 may be an existing BM-SC and eBM-SC, or derived from enhancing the existing BM-SC.

Those skilled in the art should understand that the aforesaid the GCS-AS device 1, the OCS device 2 and the BM-SC device 3 are only an example, and other existing a Group Communication Service Application Server or an Online Charging System or a broadcast multicast service center, or those that can possibly come out later should also be covered in the protection scope of the invention and included here in a way of quotation, if they are adaptable to this invention. Here, the GCS-AS device 1, the OCS device 2 and the BM-SC device 3 all can includes an electronic device that can perform numerical value calculation and process information automatically according to pre-set or pre-stored instructions, and its hardware includes, but is not limited to, a microprocessor, an Application Specific Integrated Circuit (ASIC), an Filed Programmable Gate Array (FPGA), a Digital Signal Processor (DSP), or an embedded device, etc.

Specifically, if the UE initiates a session to the GCS-AS device 1, the first sending apparatus 11 of the GCS-AS device 1 sends an online charging initial request to the corresponding OCS device 2 based on the GCS-AS Ro interface.

Here, the GCS-AS Ro interface is an interface newly introduced between the GCS-AS device 1 and the OCS device 2 according to the present invention, which is used to charge per UE's GCS-AS service usage.

For example, suppose user (e.g., user A) customizes the GCS-AS service using its own UE. If the UE initiates a session to the GCS-AS device 1 corresponding to the GCS service, e.g., the UE registers to the GCS-AS device 1, the first sending apparatus 11 of the GCS-AS device 1 sends an online charging initial request to the corresponding OCS device 2 via the GCS-AS Ro interface.

Correspondingly, the first receiving apparatus 21 of the OCS device 2 receives an online charging initial request sent by the corresponding GCS-AS device 1 when receiving the session initiated by the UE via the GCS-AS Ro interface.

Next, the first charging apparatus 23 of the OCS device 2 performs online charging on usage of GCS-AS service data of the UE in response to the online charging initial request.

Further, the second sending apparatus 22 of the OCS device 2 first determines the granted service unit and valid time information about the UE in response to the online charging initial request; then, based on the GCS-AS Ro interface, sends the granted service unit and the valid time information about the UE to the GCS-AS device 1, wherein the user balance corresponding to the UE satisfies the predetermined threshold. Here, the granted service unit corresponds to usage of the GCS-AS service data.

Here, a type of the granted service unit may be event-based (e.g., the short messaging service), or traffic-based (e.g., the downloading service), or time length-based (e.g., the call service). Here, the valid time information indicates the valid time of the key for the UE to decode the GCS-AS service data. In a specific embodiment, it may be implemented by a valid timer. Preferably, the GCS-AS device 1 can also revise or re-issue the key and/or valid time information during the grant period. The GCS-AS device 1 can also consult with the OCS device 2 about the versions of the key and valid time information.

For example, continue the above example, the first receiving apparatus 21 of the OCS device 2 receives the online charging initial request sent by the corresponding GCS-AS device 1 via the GCS-AS Ro interface. If the user balance corresponding to the UE of the user A satisfies the predetermined threshold, such as the user balance is enough, then the second sending apparatus 22 first determines the granted service unit and the valid time information in response to the online charging initial request, e.g., the charging system performs a rating process on the user A's account, balance and rates information of a corresponding GCS service, thereby obtaining the corresponding GCS service usage, so as to determine the granted service unit (e.g., the granted service unit-A) corresponding to the UE of the user A and allocate the valid time information (e.g., validity-timer-A); then, the second sending apparatus 22 sends the granted service unit and valid time information about the UE to the GCS-AS device 1.

Correspondingly, the second receiving apparatus 12 of the GCS-AS device 1 receives the granted service unit and valid time information about the UE sent by the OCS device based on the online charging initial request.

The third sending apparatus 13 sends the GCS-AS service data corresponding to the granted service unit, the valid time information, and the corresponding key to the UE via a GCI (wherein the GCI is an application interface between UE and GCS-AS defined in the existing 3GPP criteria) reference point, so as to make the UE decode the GCS-AS service data based on the key within the valid time information. Here, the GCS-AS service data may be based on the EPS bearer or MBMS bearer. Here, the key may be an encryption key or a decryption key. The key may also be allocated by the GCA-AS device 1 or allocated by the OCS device 2 and sent to the GCS-AS device 1.

Here, it should be noted that the first charging apparatus 23 of the OCS device 2 first performs online charging regarding usage of the GCS-AS service data of the UE in response to the online charging initial request, and then the second sending apparatus 22 further sends the granted service unit and valid time information regarding the UE to the GCS-AS device 1 in response to the online charging request, wherein the granted service unit corresponds to usage of the GCS-AS service data. Here, via the introduced GCS-AS Ro interface, the present invention realizes charging per UE's GCS-AS service usage. In specific embodiments, the GCS-AS device 1 can send per UE's GCS-AS service data usage to the OCS device 2, such that the OCS device 2 performs corresponding charging.

If the GCS-AS service data is based on the EPS bearer, the second charging apparatus 24 of the OCS device 2 first receives the charging request from the SGW/PGW (service gateway/packet gateway) via the Gy interface, and receives the specific rating group allocated by the PCRF (Policy and Charging Enforcement Function) device to the granted service unit and forwarded by the PCEF (Policy and Charging Rules Function) device; then, the second charging apparatus 24 performs online charging based on the specific rating group, where usage of the GCS-AS service data is transferred via the Gy interface. Here, the specific rating group is allocated by the PCRF device based on the charging policy. Here, the Gy interface is introduced between the OCS and the SGW/PGW in the existing 3GPP standard, which is used to transfer usage of the GCS-AS service on the LTE EPS bearer.

For example, for user A, when his UE initiates a session to the GCS-AS device, the GCS-AS device 1 will trigger a Rx request to the PCRF device; the PCRF device allocates a specific rating group to the GCS-AS service data about the UE and sends the specific rating group to the PCEF device; the PCEF device sends the specific rating group to the OCS device 2; then, the second charging apparatus 24 of the OCS device 2 performs online charging for the usage of the GCS-AS service data based on the specific rating group, wherein the usage of the GCS-AS service data is transmitted via the Gy interface.

Preferably, when the PCRF device sends the specific rating group to the PCEF device, the service information such as GCS-AS service data flow may be sent simultaneously, such that the PCEF device may determine it is the GCS-AS service data flow rather than other data flow.

Preferably, the GCS-AS service data at the PCEF device level may be free of charge or online charging, or sponsored online charging paid by the content provider pays.

Preferably, in a preferred embodiment, if the user's usage of the GCS-AS service data has been charged through the GCS-AS Ro, the PCEF device might not trigger Gy interface online charging to the OCS device 2; correspondingly, for the end user, the present invention avoids the double charging issue for both charging trigger from the GCS-AS Ro and the Gy online charging. In other words, for the charging of the end user, it will not charge simultaneously through GCS-AS Ro and Gy; moreover, the present invention can make the GCS-AS service over the EPS bearer is free of charge, because the user traffic over the MBMS bearer is free of charge. In another preferred embodiment, the present invention may still use Gy to perform independent charging of the usage of the EPS bearer. The specific implementation manners include: 1) for free of charge GCS-AS service data (e.g., content-based), the PCEF device does to not trigger the Gy interface online charging to the OCS device 2; 2) for online charging, if the PCEF triggers the online charging request to carry the specific rating group to the OCS device, so the OCS device 2 can apply free of charge the GCS-AS service data. The OCS device 2 can also charge the GCS-AS service data of the EPS bearer with a specific rate (the specific rate is totally based on the operation configuration); 3) the present invention can support online charging for the GCS-AS service data at the EPS bearer level, namely, sponsored by the content provider, rather than paid by the user. The Gy interface allows this capability from the PGW (packet gateway) and the MBMS. However, the business model from the operator can be different.

If the GCS-AS service data corresponding to the granted service unit of the UE is based on the MBMS bearer, the sixth sending apparatus 31 of the BM-SC device 3 sends an online charging request to the corresponding OCS device 2 via the MBMS Ro interface. Here, the MBMS Ro interface is an interface newly introduced by the present invention between the BM-SC device 3 and the OCS device 2, which is used to charge per content provider for GCS-AS service usage over MBMS bearer.

For example, for the user A, his UE joins in the MBMS group, such that the GCS-AS service data corresponding to the granted service unit of the UE is based on the MBMS bearer, then the sixth sending apparatus 31 of the BM-SC device 3 sends an online charging request to the corresponding OCS device 2 via the MBMS Ro interface.

Preferably, when the sixth sending apparatus 31 of the BM-SC device 3 sends an online charging request to the corresponding OCS device 2 based on the MBMS Ro interface, the user ID in the online request is the content provider, such that the content provider acts as the chargeable party.

Preferably, if the GCS-AS service data corresponding to the granted service unit of the UE is based on the MBMS bearer, the GCS-AS device 1 may also report the MBMS service related charging information to the OCS device 2. Here, the MBMS service related charging information includes, e.g., content provider ID, service area, TMGI (Temporary Mobile Group Identity), bearer traffic type, BM-SC gateway, elated service attributes, related UL and DL volume, session start and stop time, multicast, broadcast, etc.

Correspondingly, the sixth receiving apparatus 25 receives the online charging request sent by the corresponding BM-SC device 3 via the MBMS Ro interface in the case that the GCS-AS service data is based on the MBMS bearer.

The third charging apparatus 26 charges the content provider for providing the GCS service data, based on the online charging request.

Here, by charging the content provider for providing the GCS service data, the present invention realizes charging the end user in MBMS group messages of the MTC.

In a specific embodiment, those skilled in the art should understand that the first charging apparatus 23, the second charging apparatus 24, and the third charging apparatus 26 of the OCS device 2 may be integrated together or may be mutually independent modules.

The various apparatus of the GCS-AS device 1, the OCS device 2 and the BM-SC device 3 works continuously between each other. Specifically, if the UE initiates a session to the GCS-AS device 1, the first sending apparatus 11 of the GCS-AS device 1 continuously sends an online charging initial request to the corresponding OCS device 2 based on the GCS-AS Ro interface; correspondingly, the first receiving apparatus 21 of the OCS device 2 continuously receives the online charging initial request sent by the corresponding GCS-AS device 1 via the GCS-AS Ro interface when receiving the UE-initiated session; the first charging apparatus 23 of the OCS device 2 further continuously performs online charging to usage of the GCS-AS service data in response to the online charging initial request; the second sending apparatus 22 of the OCS device 2 continuously sends the granted service unit and valid time information about the UE to the GCS-AS device 1 via the GCS-AS Ro interface in response to the online charging initial request, wherein the user balance corresponding to the UE satisfies a predetermined threshold; correspondingly, the second receiving apparatus 12 of the GCS-AS device 1 continuously receives the granted service unit and valid time information about the UE as sent by the OCS device 2 based on the online charging initial request; the third sending apparatus 13 continuously sends the GCS-AS service data corresponding to the granted service unit, the valid time information, and the corresponding key to the UE, so as to make the UE decode the GCS-AS service data based on the key within the valid time information; if the GCS-AS service data are based on the EPS bearer, the second charging apparatus 24 of the OCS device 2 continuously performs online charging to usage of the GCS-AS service data based on the received specific rating group which is allocated for the GCS-AS service data corresponding to the granted service unit, wherein usage of the GCS-AS service data is transferred via a Gy interface; if the GCS-AS service data corresponding to the granted service unit of HE is based on the MBMS bearer, the sixth sending apparatus 31 of the BM-SC device 3 continuously sends an online charging request to the corresponding OCS device 2 based on the MBMS Ro interface; correspondingly, the sixth receiving apparatus 25 of the OCS device 2 continuously receives, via the MBMS Ro interface, an online charging request sent by the corresponding BM-SC device 3 when the GCS-AS service data are based on the MBMS bearer; the third charging apparatus 26 continuously charges the content provider of the GCS service data according to the online charging request. Here, those skilled in the art should understand that “continuously” means the various apparatus of the GCS-AS device 1, the OCS device 2 and the BM-SC device 3 continuously send and receive the online charging initial request, perform online charging to usage of GCS-AS service data, send and receive a granted service unit and valid time information about the UE, perform online charging to usage of GCS-AS service data which is based on the EPS bearer, and charge a content provider for providing said GCS service data which is based on the MBMS bearer, till the GCS-AS device 1 stops sending the online charging initial request.

Preferably, the GCS-AS device 1 further comprises a fourth sending apparatus (not shown). Specifically, if the UE initiates a session to the GCS-AS device 1, the fourth sending apparatus sends a Rx request to the corresponding PCRF device, such that the PCRF device allocates a specific rating group to the GCS-AS service data, and sends the specific rating group to the OCS device 2 via the PCEF device to which the PCRF device corresponds.

For example, for user A, when its UE initiates a session with the GCS-AS device 1, the fourth sending apparatus of the GCS-AS device 1 will trigger a Rx request to the PCRF device. The PCRF device allocates a specific rating group for the GCS-AS service data about the UE based on the charging policy and sends it to the PCEF device, such that the PCEF device sends the specific rating group to the OCS device 2.

Preferably, the GCS-AS device 1 further comprises a detecting apparatus (not shown) and a fifth sending apparatus (not shown). Specifically, when the UE is in a GCS-AS session, the detecting apparatus detects whether an update trigger condition for sending the online charging update request to the OCS device 2 is satisfied; wherein if the update trigger condition is satisfied, the fifth sending apparatus sends the online charging update request to the OCS device 2 such that the OCS device 2 performs a corresponding operation.

Specifically, when the UE is in a GCS-AS session, the detecting apparatus detects whether an update trigger condition for sending the online charging update request to the OCS device 2 is satisfied. Here, the update trigger condition includes, but not limited to, at least any one of the following: 1) the key or valid time information regarding the UE are expired; 2) the granted service units regarding the UE are used up; 3) location information of the UE is changed.

For example, for user A, suppose the location information of his UE is changed, e.g., the user carries the UE from the South to the North, the detecting apparatus judges that an update trigger condition for sending an online charging update request to the OCS device 2 is satisfied.

If the update trigger condition is satisfied, the fifth sending apparatus sends the online charging update request to the OCS device, such that the OCS device 2 performs a corresponding operation.

For example, for user A, suppose the key or the valid time information of his UE expires and the detecting apparatus judges that the update trigger condition for sending an online charging update request to the OCS device 2 is satisfied, the fifth sending apparatus sends the online charging update request to the OCS device 2, e.g., requesting the OCS device 2 to extend the valid time information or requesting the OCS device 2 to re-authorize the GCS-AS service, such that the OCS device 2 extends the valid time information or re-authorizes the GCS-AS service.

For another example, for user A, suppose the granted service units of its UE are used up, the detecting apparatus detects that the update trigger condition for sending an online charging update to the OCS device 2 is satisfied, then the fifth sending apparatus sends the online charging update request to the OCS device 2, e.g., requesting the OCS device 2 to re-authorize the GCS-AS service.

Preferably, the GCS-AS device 1 further comprises a reporting apparatus (not shown). Specifically, the reporting apparatus reports the charging related information about the GCS service data to the OCS device 2. Here, the charging related information about the GCS service data includes, but not limited to, for example: 1) subscriber ID, subscriber location information, service area, TMGI, bearer traffic type, gateway access, radio access type, related service attributes, user join and leave GCS service time, related UL and DL service usage, etc.

Preferably, if the GCS-AS service data is based on the MBMS bearer, the GCS-AS device 1 saves at least one of temporary mappings as follows:

the temporary mapping between the user identification of the UE, the identification of the MBMS group to which the UE belongs, and said key;

the temporary mapping between the user identification of the UE, the identification of the MBMS group to which the UE belongs, and said valid time information;

the temporary mapping between a Temporary Mobile Group Identification of the UE and the identification of said GCS service data.

Preferably, if the user balance corresponding to the UE does not satisfy the predetermined threshold, the second sending apparatus 22 of the OCS device 2 further can reject the online charging initial request such that the OCS device 2 or the GCS-AS device 1 will not allocate a key to the UE. Without the key, the UE cannot decode the message from the GCS-AS device 1.

Preferably, if the UE de-registers or leaves the GCS-AS service, the UE reports the GCS-AS device 1 through the GCI; therefore, the GCS-AS device 1 will trigger the online charging termination request.

In one preferred embodiment (with reference to FIG. 1), if the UE initiates a session to the GCS-AS device 1, the first sending apparatus 11 of the GCS-AS device 1 sends an online charging initial request to the corresponding OCS device 2 via the GCS-AS Ro interface, wherein the online charging initial request includes a communication mode of the UE. Here, the communication mode includes unicast, multicast, broadcast, etc. Correspondingly, when the OCS device 2 performs online charging to usage of the GCS-AS service data of the UE, it can apply the different tariff based on per UE's GCS communication mode.

Here, the present invention sends the communication mode of the UE to the OCS device 2, such that the OCS device 2 may charge with different tariff based on a communication mode of the UE. Therefore, for a subscriber using the GCS service, i.e., for a user in the GCS-AS group, the present invention supports the charging for each UE.

Here, it should be further noted that, in the present invention, the provider of the GCS-AS service may be the same or different of the wireless network. Specifically:

1) If the provider of GCS-AS service is same as the provider of wireless network, all the online charging Ro interfaces (include GCS AS Ro, Gy, MBMS-Ro) will be triggered by the same network in H-PLMN (Home Public Land Mobile Network);

2) If the provider of the GCS-AS service is different from wireless network, the GCS-AS Ro will be triggered by a network of a third party, while the Gy and the MBMS Ro will be triggered by the mobile operator/provider's network in the H-PLMN, The GCS-AS OCS (i.e., the provider of the GCS-AS service) can be integrated into the GCS-AS device 1 or separate from the GCS-AS device 1, e.g., located nearby the GCS-AS device 1.

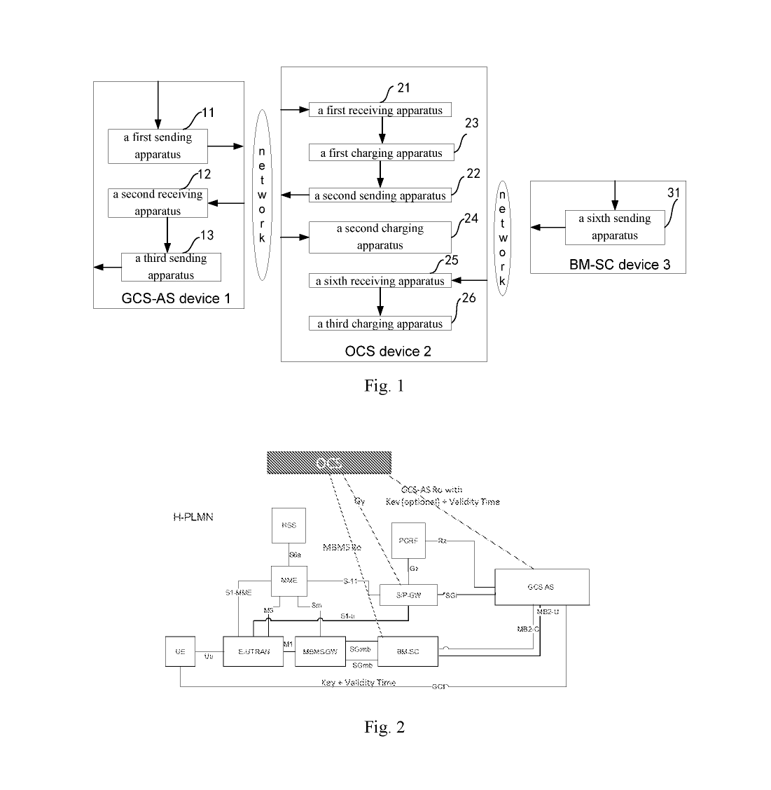

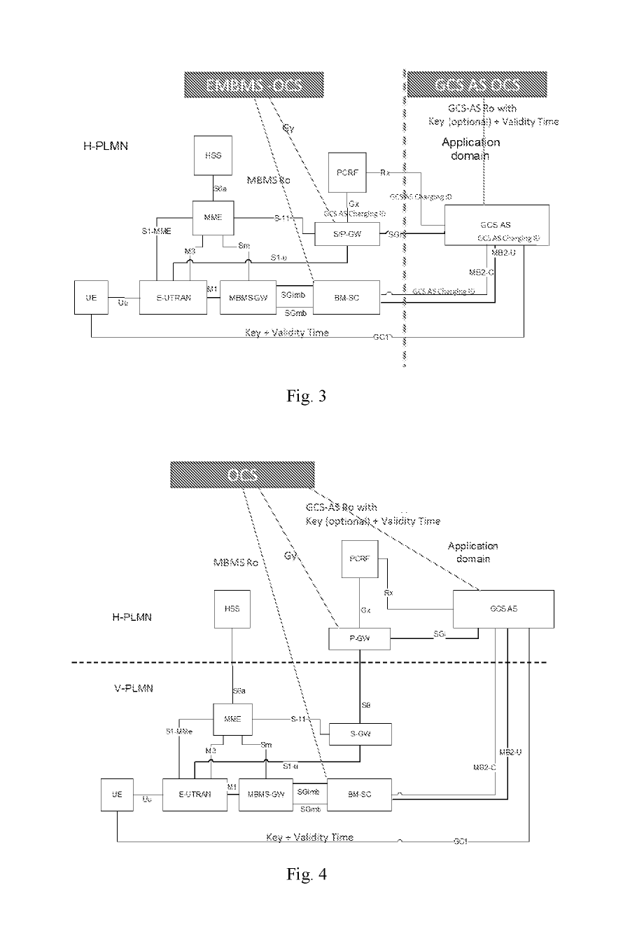

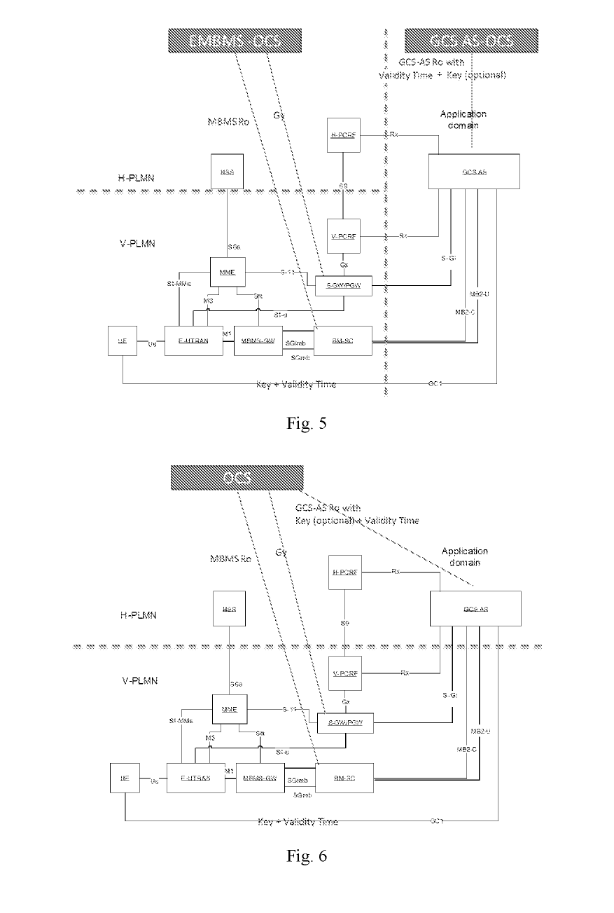

For a roaming user, the online charging should follow the following existing online charging for roaming users, as defined in 3GPP. FIGS. 2-6 show GCS online charging diagrams of subscribers using GCS-AS service in non-roaming/non-roaming network architecture, and the provider of the GCS-AS service is the same or different of the wireless network. It should be noted that besides the MBMS Ro and GCS-AS Ro interfaces, respective interfaces as shown in FIGS. 2-6 are known to those skilled in the art. For the sake of simplicity, details are no longer described and only included here in a way of quotation.

Here, It also should be noted that this invention requires additions of sub-AVPs in Diameter MBMS-Information AVP in GCS-AS Ro, Gy Ro and MBMS Ro.

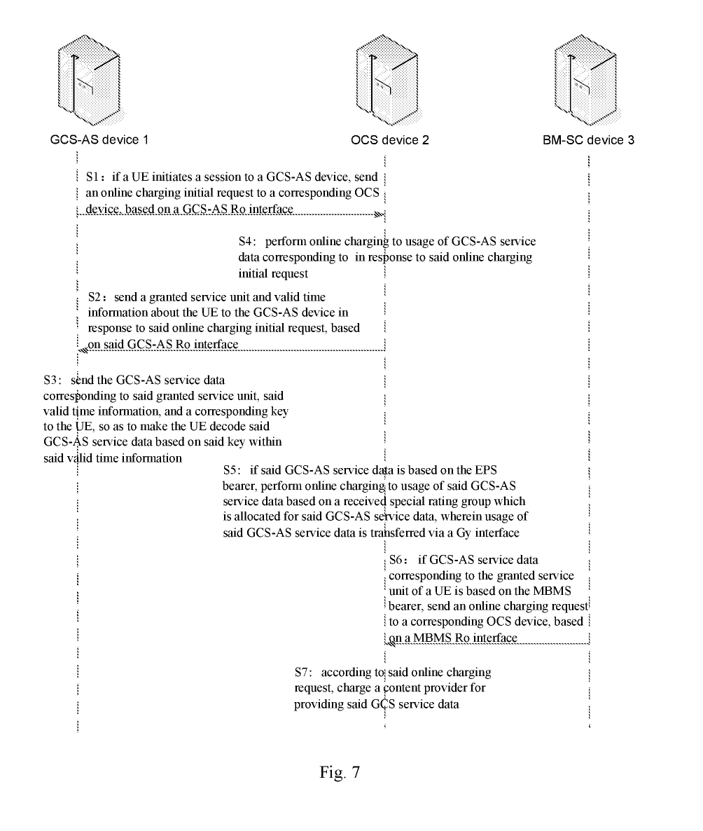

FIG. 7 shows a flowchart of a method for performing online charging to GCS over LTE EPS/MBMS with cooperation among a GCS-AS device, an OCS device and a BM-SC device according to another embodiment of the present invention.

Wherein, this method includes the step S1, the step S2, step S3, step S4, step S5, step S6 and step S7. Specifically, if the UE initiates a session to the GCS-AS device 1, in the step S1, the GCS-AS device 1 sends an online charging initial request to the corresponding OCS device 2 based on the GCS-AS Ro interface; correspondingly, the OCS device 2 receives the online charging initial request sent by the corresponding GCS-AS device 1 via the GCS-AS Ro interface when receiving the UE-initiated session; in the step S4, the OCS device 2 further performs online charging to usage of the GCS-AS service data in response to the online charging initial request; in the step S2, the OCS device 2 sends the granted service unit and valid time information about the UE to the GCS-AS device 1 via the GCS-AS Ro interface in response to the online charging initial request, wherein the user balance corresponding to the UE satisfies a predetermined threshold; correspondingly, the GCS-AS device 1 receives the granted service unit and valid time information about the UE as sent by the OCS device 2 based on the online charging initial request; in the step S3, the GCS-AS device 1 sends the GCS-AS service data corresponding to the granted service unit, the valid time information, and the corresponding key to the UE, so as to make the UE decode the GCS-AS service data based on the key within the valid time information; if the GCS-AS service data are based on the EPS bearer, in the step S5, the OCS device 2 performs online charging to usage of the GCS-AS service data based on the received specific rating group which is allocated for the GCS-AS service data corresponding to the granted service unit, wherein usage of the GCS-AS service data is transferred via a Gy interface; if the GCS-AS service data corresponding to the granted service unit of UE is based on the MBMS bearer, in the step S6, the BM-SC device 3 sends an online charging request to the corresponding OCS device 2 based on the MBMS Ro interface; correspondingly, the OCS device 2 receives, via the MBMS Ro interface, an online charging request sent by the corresponding BM-SC device 3 when the GCS-AS service data are based on the MBMS bearer; in the step S7, the OCS device 2 charges the content provider of the GCS service data according to the online charging request.

Here, the GCS-AS device 1 refers to a Group Communication Service (GCS) Application Server (AS) can use EPS bearer services and may use in addition MBMS bearer services for transferring application signaling and data between the GCS AS device 1 and the UE(s). In a specific embodiment, the GCS-AS device 1 may be an existing GCS-AS, e.g., the GCS-AS for a group communication system as introduced in the 3GPP 4G LTE, which may also be derived by enhancing the existing GCS-AS.

Here, the OCS device 2 refers to an Online Charging System (OCS) that may perform real-time interactive charging with the system based on services usage. In a specific embodiment, the OCS device 2 may be an existing OCS or derived from enhancing the existing OCS.

Here, the BM-SC device 3 refers to a functional entity (i.e., a broadcast multicast service center) that may perform provision and management of MBMS service. For example, for a content provider, the BM-SC device 3 is an entry for the MBMS service content; for a bearer network, the BM-SC device 3 is configured to authorize and initiate the MBMS service and schedule and transmit the MBMS service content. In an specific embodiment, the BM-SC device 3 may be an existing BM-SC and eBM-SC, or derived from enhancing the existing BM-SC.

Those skilled in the art should understand that the aforesaid the GCS-AS device 1, the OCS device 2 and the BM-SC device 3 are only an example, and other existing a Group Communication Service Application Server or an Online Charging System or a broadcast multicast service center or those that can possibly come out later should also be covered in the protection scope of the invention and included here in a way of quotation, if they are adaptable to this invention. Here, the GCS-AS device 1, the OCS device 2 and the BM-SC device 3 all can includes an electronic device that can perform numerical value calculation and process information automatically according to pre-set or pre-stored instructions, and its hardware includes, but is not limited to, a microprocessor, an Application Specific Integrated Circuit (ASIC), an Filed Programmable Gate Array (FPGA), a Digital Signal Processor (DSP), or an embedded device, etc.

Specifically, if the UE initiates a session to the GCS-AS device 1, in the step S1, the GCS-AS device 1 sends an online charging initial request to the corresponding OCS device 2 based on the GCS-AS Ro interface.

Here, the GCS-AS Ro interface is an interface newly introduced between the GCS-AS device 1 and the OCS device 2 according to the present invention, which is used to charge per UE's GCS-AS service usage.

For example, suppose user (e.g., user A) customizes the GCS-AS service using its own UE. If the UE initiates a session to the GCS-AS device 1 corresponding to the GCS service, e.g., the UE registers to the GCS-AS device 1, in the step S1, the GCS-AS device 1 sends an online charging initial request to the corresponding OCS device 2 via the GCS-AS Ro interface.

Correspondingly, the OCS device 2 receives an online charging initial request sent by the corresponding GCS-AS device 1 when receiving the session initiated by the UE via the GCS-AS Ro interface.

Next, in the step S4, the OCS device 2 performs online charging on usage of GCS-AS service data of the UE in response to the online charging initial request.

Further, in the step S2, the OCS device 2 first determines the granted service unit and valid time information about the UE in response to the online charging initial request; then, based on the GCS-AS Ro interface, sends the granted service unit and the valid time information about the UE to the GCS-AS device 1, wherein the user balance corresponding to the UE satisfies the predetermined threshold. Here, the granted service unit corresponds to usage of the GCS-AS service data.

Here, a type of the granted service unit may be event-based (e.g., the short messaging service), or traffic-based (e.g., the downloading service), or time length-based (e.g., the call service). Here, the valid time information indicates the valid time of the key for the UE to decode the GCS-AS service data. In a specific embodiment, it may be implemented by a valid timer. Preferably, the GCS-AS device 1 can also revise or re-issue the key and/or valid time information during the grant period. The GCS-AS device 1 can also consult with the OCS device 2 about the versions of the key and valid time information.

For example, continue the above example, in the step S1, the OCS device 2 receives the online charging initial request sent by the corresponding GCS-AS device 1 via the GCS-AS Ro interface. If the user balance corresponding to the UE of the user A satisfies the predetermined threshold, such as the user balance is enough, then in the step S2, the OCS device 2 first determines the granted service unit and the valid time information in response to the online charging initial request, e.g., the charging system performs a rating process on the user A's account, balance and rates information of a corresponding GCS service, thereby obtaining the corresponding GCS service usage, so as to determine the granted service unit (e.g., the granted service unit-A) corresponding to the UE of the user A and allocate the valid time information (e.g., validity-timer-A); then, in the step S2, the OCS device 2 sends the granted service unit and valid time information about the UE to the GCS-AS device 1.

Correspondingly, the GCS-AS device 1 receives the granted service unit and valid time information about the UE sent by the OCS device based on the online charging initial request.

In the step S3, the GCS-AS device 1 sends the GCS-AS service data corresponding to the granted service unit, the valid time information, and the corresponding key to the UE via a GCI (wherein the GCI is an application interface between UE and GCS-AS defined in the existing 3GPP criteria) reference point, so as to make the UE decode the GCS-AS service data based on the key within the valid time information. Here, the GCS-AS service data may be based on the EPS bearer or MBMS bearer. Here, the key may be an encryption key or a decryption key. The key may also be allocated by the GCA-AS device 1 or allocated by the OCS device 2 and sent to the GCS-AS device 1.

Here, it should be noted that the OCS device 2 first performs online charging regarding usage of the GCS-AS service data of the UE in response to the online charging initial request in the step S4, and then the OCS device 2 further sends the granted service unit and valid time information regarding the UE to the GCS-AS device 1 in response to the online charging request, wherein the granted service unit corresponds to usage of the GCS-AS service data in the step S2. Here, via the introduced GCS-AS Ro interface, the present invention realizes charging per UE's GCS-AS service usage. In specific embodiments, the GCS-AS device 1 can send per UE's GCS-AS service data usage to the OCS device 2, such that the OCS device 2 performs corresponding charging.

If the GCS-AS service data is based on the EPS bearer, in the step S5, the OCS device 2 first receives the charging request from the SGW/PGW (service gateway/packet gateway) via the Gy interface, and receives the specific rating group allocated by the PCRF (Policy and Charging Enforcement Function) device to the granted service unit and forwarded by the PCEF (Policy and Charging Rules Function) device; then, the OCS device 2 performs online charging based on the specific rating group, where usage of the GCS-AS service data is transferred via the Gy interface. Here, the specific rating group is allocated by the PCRF device based on the charging policy. Here, the Gy interface is introduced between the OCS and the SGW/PGW in the existing 3GPP standard, which is used to transfer usage of the GCS-AS service on the LTE EPS bearer.

For example, for user A, when his UE initiates a session to the GCS-AS device, the GCS-AS device 1 will trigger a Rx request to the PCRF device; the PCRF device allocates a specific rating group to the GCS-AS service data about the UE and sends the specific rating group to the PCEF device; the PCEF device sends the specific rating group to the OCS device 2; then, in the step S5, the OCS device 2 performs online charging for the usage of the GCS-AS service data based on the specific rating group, wherein the usage of the GCS-AS service data is transmitted via the Gy interface.

Preferably, when the PCRF device sends the specific rating group to the PCEF device, the service information such as GCS-AS service data flow may be sent simultaneously, such that the PCEF device may determine it is the GCS-AS service data flow, rather than other data flow.

Preferably, the GCS-AS service data at the PCEF device level may be free of charge or online charging, or sponsored online charging paid by the content provider pays.

Preferably, in a preferred embodiment, if the user's usage of the GCS-AS service data has been charged through the GCS-AS Ro, the PCEF device might not trigger Gy interface online charging to the OCS device 2; correspondingly, for the end user, the present invention avoids the double charging issue for both charging trigger from the GCS-AS Ro and the Gy online charging. In other words, for the charging of the end user, it will not charge simultaneously through GCS-AS Ro and Gy; moreover, the present invention can make the GCS-AS service over the EPS bearer is free of charge, because the user traffic over the MBMS bearer is free of charge. In another preferred embodiment, the present invention may still use Gy to perform independent charging of the usage of the EPS bearer. The specific implementation manners include: 1) for free of charge GCS-AS service data (e.g., content-based), the PCEF device does not trigger the Gy interface online charging to the OCS device 2; 2) for online charging, if the PCEF triggers the online charging request to carry the specific rating group to the OCS device, so the OCS device 2 can apply free of charge the GCS-AS service data. The OCS device 2 can also charge the GCS-AS service data of the EPS bearer with a specific rate (the specific rate is totally based on the operation configuration); 3) the present invention can support online charging for the GCS-AS service data at the EPS bearer level, namely, sponsored by the content provider, rather than paid by the user. The Gy interface allows this capability from the PGW (packet gateway) and the MBMS. However, the business model from the operator can be different.

If the GCS-AS service data corresponding to the granted service unit of the UE is based on the MBMS bearer, in the step S6, the BM-SC device 3 sends an online charging request to the corresponding OCS device 2 via the MBMS Ro interface. Here, the MBMS Ro interface is an interface newly introduced by the present invention between the BM-SC device 3 and the OCS device 2, which is used to charge per content provider for GCS-AS service usage over MBMS bearer.

For example, for the user A, his UE joins in the MBMS group, such that the GCS-AS service data corresponding to the granted service unit of the UE is based on the MBMS bearer, then in the step S6, the BM-SC device 3 sends an online charging request to the corresponding OCS device 2 via the MBMS Ro interface.

Preferably, when in the step S6, the BM-SC device 3 sends an online charging request to the corresponding OCS device 2 based on the MBMS Ro interface, the user ID in the online request is the content provider, such that the content provider acts as the chargeable party.

Preferably, if the GCS-AS service data corresponding to the granted service unit of the UE is based on the MBMS bearer, the GCS-AS device 1 may also report the MBMS service related charging information to the OCS device 2. Here, the MBMS service related charging information includes, e.g., content provider ID, service area, TMGI (Temporary Mobile Group Identity), bearer traffic type, BM-SC gateway, elated service attributes, related UL, and DL volume, session start and stop time, multicast, broadcast, etc.

Correspondingly, the OCS device 2 receives the online charging request sent by the corresponding BM-SC device 3 via the MBMS Ro interface in the case that the GCS-AS service data is based on the MBMS bearer.

In the step S7, the OCS device 2 charges the content provider for providing the GCS service data, based on the online charging request.

Here, by charging the content provider for providing the GCS service data, the present invention realizes charging the end user in MBMS group messages of the MTC.

The various steps of the GCS-AS device 1, the OCS device 2 and the BM-SC device 3 works continuously between each other. Specifically, if the UE initiates a session to the GCS-AS device 1, in the step S1, the GCS-AS device 1 continuously sends an online charging initial request to the corresponding OCS device 2 based on the GCS-AS Ro interface; correspondingly, the OCS device 2 continuously receives the online charging initial request sent by the corresponding GCS-AS device 1 via the GCS-AS Ro interface when receiving the UE-initiated session; in the step S4, the OCS device 2 further continuously performs online charging to usage of the GCS-AS service data in response to the online charging initial request; in the step S2, the OCS device 2 continuously sends the granted service unit and valid time information about the UE to the GCS-AS device 1 via the GCS-AS Ro interface in response to the online charging initial request, wherein the user balance corresponding to the UE satisfies a predetermined threshold; correspondingly, the GCS-AS device 1 continuously receives the granted service unit and valid time information about the UE as sent by the OCS device 2 based on the online charging initial request; in the step S3, the GCS-AS device 1 continuously sends the GCS-AS service data corresponding to the granted service unit, the valid time information, and the corresponding key to the UE, so as to make the UE decode the GCS-AS service data based on the key within the valid time information; if the GCS-AS service data are based on the EPS bearer, in the step S5, the OCS device 2 continuously performs online charging to usage of the GCS-AS service data based on the received specific rating group which is allocated for the GCS-AS service data corresponding to the granted service unit, wherein usage of the GCS-AS service data is transferred via a Gy interface; if the GCS-AS service data corresponding to the granted service unit of UE is based on the MBMS bearer, in the step S6, the BM-SC device 3 continuously sends an online charging request to the corresponding OCS device 2 based on the MBMS Ro interface; correspondingly, the OCS device 2 continuously receives, via the MBMS Ro interface, an online charging request sent by the corresponding BM-SC device 3 when the GCS-AS service data are based on the MBMS bearer; in the step S7, the OCS device 2 continuously charges the content provider of the GCS service data according to the online charging request. Here, those skilled in the art should understand that “continuously” means the various steps of the GCS-AS device 1, the OCS device 2 and the BM-SC device 3 continuously send and receive the online charging initial request, perform online charging to usage of GCS-AS service data, send and receive a granted service unit and valid time information about the UE, perform online charging to usage of GCS-AS service data which is based on the EPS bearer, and charge a content provider for providing said GCS service data which is based on the MBMS bearer, till the GCS-AS device 1 stops sending the online charging initial request.

Preferably, the GCS-AS device 1 further comprises the step S8 (not shown) Specifically, if the UE initiates a session to the GCS-AS device 1, in the step S8, the GCS-AS device 1 sends a Rx request to the corresponding PCRF device, such that the PCRF device allocates a specific rating group to the GCS-AS service data, and sends the specific rating group to the OCS device 2 via the PCEF device to which the PCRF device corresponds.

For example, for user A, when its UE initiates a session with the GCS-AS device 1, in the step S8, the GCS-AS device 1 will trigger a Rx request to the PCRF device. The PCRF device allocates a specific rating group for the GCS-AS service data about the UE based on the charging policy and sends it to the PCEF device, such that the PCEF device sends the specific rating group to the OCS device 2.

Preferably, the GCS-AS device 1 further comprises the step S9 (not shown) and the step S10 (not shown). Specifically, when the UE is in a GCS-AS session, in the step S9, the GCS-AS device 1 detects whether an update trigger condition for sending the online charging update request to the OCS device 2 is satisfied; wherein if the update trigger condition is satisfied, in the step S10, the GCS-AS device 1 sends the online charging update request to the OCS device 2 such that the OCS device 2 performs a corresponding operation.

Specifically, when the UE is in a GCS-AS session, in the step S9, the GCS-AS device 1 detects whether an update trigger condition for sending the online charging update request to the OCS device 2 is satisfied. Here, the update trigger condition includes, but not limited to, at least any one of the following: 1) the key or valid time information regarding the UE are expired; 2) the granted service units regarding the UE are used up; 3) location information of the UE is changed.

For example, for user A, suppose the location information of his UE is changed, e.g., the user carries the UE from the South to the North, in the step S9, the GCS-AS device 1 judges that an update trigger condition for sending an online charging update request to the OCS device 2 is satisfied.

If the update trigger condition is satisfied, in the step S10, the GCS-AS device 1 sends the online charging update request to the OCS device, such that the OCS device 2 performs a corresponding operation.

For example, for user A, suppose the key or the valid time information of his UE expires and the GCS-AS device 1 judges that the update trigger condition for sending an online charging update request to the OCS device 2 is satisfied in the step S9, then the GCS-AS device 1 sends the online charging update request to the OCS device 2 in the step S10, e.g., requesting the OCS device 2 to extend the valid time information or requesting the OCS device 2 to re-authorize the GCS-AS service, such that the OCS device 2 extends the valid time information or re-authorizes the GCS-AS service.

For another example, for user A, suppose the granted service units of its UE are used up, in the step S9, the GCS-AS device 1 detects that the update trigger condition for sending an online charging update to the OCS device 2 is satisfied, then in the step S10, the GCS-AS device 1 sends the online charging update request to the OCS device 2, e.g., requesting the OCS device 2 to re-authorize the GCS-AS service.

Preferably, the GCS-AS device 1 further comprises the step S11 (not shown). Specifically, in the step S11, the GCS-AS device 1 reports the charging related information about the GCS service data to the OCS device 2. Here, the charging related information about the GCS service data includes, but not limited to, for example: 1) subscriber ID, subscriber location information, service area, TMGI, bearer traffic type, gateway access, radio access type, related service attributes, user join and leave GCS service time, related UL and DL service usage, etc.

Preferably, if the GCS-AS service data is based on the MBMS bearer, the GCS-AS device 1 saves at least one of temporary mappings as follows:

the temporary mapping between the user identification of the UE, the identification of the MBMS group to which the UE belongs, and said key;

the temporary mapping between the user identification of the UE, the identification of the MBMS group to which the LE belongs, and said valid time information;

the temporary mapping between a Temporary Mobile Group Identification of the UE and the identification of said GCS service data.

Preferably, if the user balance corresponding to the UE does not satisfy the predetermined threshold, in the step S2, the OCS device 2 further can reject the online charging initial request such that the OCS device 2 or the GCS-AS device 1 will not allocate a key to the UE. Without the key, the UE cannot decode the message from the GCS-AS device 1.

Preferably, if the UE de-registers or leaves the GCS-AS service, the UE reports the GCS-AS device 1 through the GCI; therefore, the GCS-AS device 1 will trigger the online charging termination request.

In one preferred embodiment (with reference to FIG. 7), if the UE initiates a session to the GCS-AS device 1, in the step S1, the GCS-AS device 1 sends an online charging initial request to the corresponding OCS device 2 via the GCS-AS Ro interface, wherein the online charging initial request includes a communication mode of the UE. Here, the communication mode includes unicast, multicast, broadcast, etc. Correspondingly, when the OCS device 2 performs online charging to usage of the GCS-AS service data of the UE, it can apply the different tariff based on per UE's GCS communication mode.

Here, the present invention sends the communication mode of the UE to the OCS device 2, such that the OCS device 2 may charge with different tariff based on a communication mode of the UE. Therefore, for a subscriber using the GCS service, i.e., for a user in the GCS-AS group, the present invention supports the charging for each UE.

Here, it should be further noted that, in the present invention, the provider of the GCS-AS service may be the same or different of the wireless network. Specifically:

1) If the provider of GCS-AS service is same as the provider of wireless network, all the online charging Ro interfaces (include GCS AS Ro, Gy, MBMS-Ro) will be triggered by the same network in H-PLMN (Home Public Land Mobile Network);

2) if the provider of the GCS-AS service is different from wireless network, the GCS-AS Ro will be triggered by a network of a third party, while the Gy and the MBMS Ro will be triggered by the mobile operator/provider's network in the H-PLMN. The GCS-AS OCS (i.e., the provider of the GCS-AS service) can be integrated into the GCS-AS device 1 or separate from the GCS-AS device 1, e.g., located nearby the GCS-AS device 1.

For a roaming user, the online charging should follow the following existing online charging for roaming users, as defined in 3GPP. FIGS. 2-6 show GCS online charging diagrams of subscribers using GCS-AS service in non-roaming/non-roaming network architecture, and the provider of the GCS-AS service is the same or different of the wireless network. It should be noted that besides the MBMS Ro and GCS-AS Ro interfaces, respective interfaces as shown in FIGS. 2-6 are known to those skilled in the art. For the sake of simplicity, details are no longer described and only included here in a way of quotation.

Here, it also should be noted that this invention requires additions of sub-AVPs in Diameter MBMS-Information AVP in GCS-AS Ro, Gy Ro and MBMS Ro.

It needs to note that the invention can be implemented in software and/or a combination of software and hardware, for example, the invention can be implemented by using an Application Specific Integrated Circuit (ASIC), a general purpose computer or any other similar hardware equipment. In one embodiment, the software program of this invention can be executed by a processor to accomplish the aforesaid steps or functions. Likewise, the software program (including the relevant data structure) of the invention can be stored in a computer readable recording medium, for example, RAM memory, magneto-optical drive or floppy disk and similar devices. In addition, some steps or functions of the invention can be realized by using hardware, for example, a circuit that cooperates with the processor to perform various steps or functions.

In addition, part of the invention can be applied as a computer program product, such as a computer program instruction. When the instruction is executed by the computer, the method and/or technical solution according to this invention may be called or provided through an operation of the computer. However, the program instruction for calling the method of the invention may possibly be stored in a fixed or movable recording medium, and/or be transmitted via broadcasting or other signal carrier mediums, and/or be stored in the operation memory of a computer device that is running according to said program instruction. Here, there is one device included according to an embodiment of the invention. Said device comprises a memory for storing computer program instructions and a processor for executing program instructions. This device is triggered to operate the methods and/or technical solutions based on the aforesaid embodiments of the invention when the computer program instructions are executed by said processor.

To those skilled in the art, apparently the invention is not limited to the details of the aforementioned exemplary embodiments. Moreover, under the premise of not deviating from the spirit or fundamental characteristics of the invention, this invention can be accomplished in other specific forms. Therefore, the embodiments should be considered exemplary and non-restrictive no matter from which point. The scope of the invention is defined by the appended claims instead of the above description, and aims at covering the meanings of the equivalent components falling into the claims and all changes within the scope in this invention. Any reference sign in the claims shall not be deemed as limiting the concerned claims. Besides, apparently the word “comprise/include” does not exclude other components or steps, singular numbers does not exclude complex numbers, the plurality of components or means mentioned in device claims may also be accomplished by one component or means through software or hardware, the wording like first and second are only used to represent names rather than any specific order.

1. A method for performing online charging to GCS over LTE EPS/MBMS, wherein the method comprises:
a. if a UE initiates a session to a GCS-AS device, the GCS-AS device sending an online charging initial request to a corresponding OCS device, based on a GCS-AS Ro interface;
b. the OCS device sending a granted service unit and valid time information about the UE to the GCS-AS device in response to said online charging initial request, based on said GCS-AS Ro interface, wherein the user balance corresponding to the UE satisfies a predetermined threshold;
c. the GCS-AS device sending the GCS-AS service data corresponding to said granted service unit, said valid time information, and a corresponding key to the UE, so as to make the UE decode said GCS-AS service data based on said key within said valid time information;
wherein the method further comprises:
d. the OCS device further performing online charging to usage of said GCS-AS service data in response to said online charging initial request;
e. if said GCS-AS service data is based on the EPS bearer, the OCS device performing online charging to usage of said GCS-AS service data based on a special rating group, wherein said special rating group is allocated by a PCRF device for said GCS-AS service data, and usage of said GCS-AS service data is transferred via a Gy interface;
f. if said GCS-AS service data is based on the MBMS bearer, the OCS device charging a content provider for providing said GCS service data in response to an online charging request that a BM-SC device sends to the OCS device via a MBMS Ro interface.

2. The method according to claim 1, the method further comprises:
if the UE initiates a session to the GCS-AS device, the GCS-AS device sending a Rx request to the PCRF device, such that the PCRF device allocates said special rating group for said GCS-AS service data and sends said special rating group to the OCS device via a PCEF device corresponding to the PCRF device.

3. The method according to claim 1, wherein the step b further comprises:
if the user balance corresponding to the UE does not satisfy the predetermined threshold, the OCS device rejecting said online charging initial request.

4. The method according to claim 1, wherein the method further comprises:
when the UE is in a GCS-AS session, the GCS-AS device detecting whether an update trigger condition for sending an online charging update request to the OCS device is satisfied;
if the update trigger condition is satisfied, the GCS-AS device sending said online charging update request to the OCS device, such that the OCS device performs a corresponding operation.

5. The method according to claim 1, wherein the method further comprises:
the GCS-AS device reporting charging related information about said GCS service data to the OCS device.

6. The method according to claim 1, wherein if said GCS-AS service data is based on the MBMS bearer, the GCS-AS device saves at least any one of the following temporary mappings:
the temporary mapping between the user identification of the UE, the identification of the MBMS group to which the UE belongs, and said key;
the temporary mapping between the user identification of the UE, the identification of the MBMS group to which the UE belongs, and said valid time information;
the temporary mapping between a Temporary Mobile Group Identification of the UE and the identification of said GCS service data.

7. A GCS-AS device for performing online charging to GCS over LTE EPS/MBMS, wherein the GCS-AS device comprises:
a first sending apparatus configured to, if a UE initiates a session to a GCS-AS device, send an online charging initial request to a corresponding OCS device, based on a GCS-AS Ro interface;
a second receiving apparatus configured to, receive a granted service unit and valid time information about the UE, which are sent by the OCS device according to said online charging initial request;
a third sending apparatus configured to, send the GCS-AS service data corresponding to said granted service unit, said valid time information, and a corresponding key to the UE, so as to make the UE decode said GCS-AS service data based on said key within said valid time information.

8. The GCS-AS device according to claim 7, wherein the GCS-AS device further comprises:
a forth sending apparatus configured to, if the UE initiates a session to the GCS-AS device, send a Rx request to a corresponding PCRF device, such that the PCRF device allocates a special rating group for said GCS-AS service data and sends said special rating group to the OCS device via a PCEF device corresponding to the PCRF device.

9. The GCS-AS device according to claim 7, wherein the GCS-AS device further comprises:
a detecting apparatus configured to, when the UE is in a GCS-AS session, detect whether an update trigger condition for sending an online charging update request to the OCS device is satisfied;
a fifth sending apparatus configured to, if the update trigger condition is satisfied, send said online charging update request to the OCS device, such that the OCS device performs a corresponding operation.

10. The GCS-AS device according to claim 7, wherein the GCS-AS device further comprises:
a reporting apparatus configured to, report charging related information about said GCS service data to the OCS device.

11. The GCS-AS device according to claim 7, wherein if said GCS-AS service data is based on the MBMS bearer, the GCS-AS device saves at least any one of the following temporary mappings:
the temporary mapping between the user identification of the UE, the identification of the MBMS group to which the UE belongs, and said key;
the temporary mapping between the user identification of the UE, the identification of the MBMS group to which the UE belongs, and said valid time information;
the temporary mapping between a Temporary Mobile Group Identification of the UE and the identification of said GCS service data.

12. An OCS device for performing online charging to GCS over LTE EPS/MBMS, wherein the OCS device comprises:
a first receiving apparatus configured to, receive an online charging initial request, which is sent by a corresponding a GCS-AS device based on a GCS-AS Ro interface when receiving a session initiated by a UE;
a second sending apparatus configured to, send a granted service unit and valid time information about the UE to the GCS-AS device in response to said online charging initial request, based on said GCS-AS Ro interface, wherein the user balance corresponding to the UE satisfies a predetermined threshold;
wherein, the OCS device further comprises:
a first charging apparatus configured to, perform online charging to usage of GCS-AS service data corresponding to said granted service unit in response to said online charging initial request;
a second charging apparatus configured to, if said GCS-AS service data is based on the EPS bearer, perform online charging to usage of said GCS-AS service data based on a received special rating group which is allocated for said GCS-AS service data, wherein usage of said GCS-AS service data is transferred via a Gy interface;
wherein, the OCS device further comprises:
a sixth receiving apparatus configured to, receive an online charging request, which is sent by a corresponding BM-SC device when said GCS-AS service data is based on the MBMS bearer, based on a MBMS Ro interface;
a third charging apparatus configured to, according to said online charging request, charge a content provider for providing said GCS service data.

13. The OCS device according to claim 12, wherein, the second charging apparatus further configured to:
if the user balance corresponding to the UE does not satisfy the predetermined threshold, reject said online charging initial request.

14. A BM-SC device for performing online charging to GCS over LTE EPS/MBMS, wherein the BM-SC device comprises:
a sixth sending apparatus configured to, if GCS-AS service data corresponding to the granted service unit of a UE is based on the MBMS bearer, send an online charging request to a corresponding OCS device, based on a MBMS Ro interface.

15. (canceled)
